(19) United States
(12) Patent Application Publication
(10) Pub. No.: US 2010/0230976 A1
(43) Pub. Date: Sep. 16, 2010

(54) Self-Generating Device for Exercising Equipment

(76) Inventor: Ku-Ming Chou, Da Jia Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/401,018

(22) Filed: Mar. 10, 2009

(51) Int. Cl. H02K 7/116; F02B 67/00; F03G 5/06

(52) U.S. Cl. 290/1 C

(57) ABSTRACT

A generating device for an exercising equipment includes a power source, a speed increasing unit and a generating unit. The generating unit includes a rotor, a stator located in the rotor and a driven member secured on the rotor and provided with a driven gear. The speed increasing unit includes a drive member having a first portion rotated by the power source and a second portion provided with a drive gear and a plurality of transmission gears each intermeshing with the drive gear and the driven gear. The drive gear has a diameter greater than that of each of the transmission gears so that the rotation speed of each of the transmission gears is greater than that of the drive member to increase the rotation speed of the rotor and to enhance the generating efficiency of the generating unit.

### BACKGROUND OF THE INVENTION

1. Field of the Invention

The present invention relates to a generating device and, more particularly, to a self-generating device for an exercising equipment, such as an exercising bike, a treadmill and the like.

2. Description of the Related Art

A conventional exercising equipment, such as an exercising bike and the like, comprises a pedal unit, a damping unit, and a display unit. The pedal unit is driven by pedalling of a user. The damping unit provides a damping action to pedalling of the user to achieve an exercising effect. The display unit has video and audio functions to provide an amusement to the user during the exercising process. However, the exercising equipment needs a larger electric power that is supplied by an external power supply, thereby consuming a larger electric energy.

### BRIEF SUMMARY OF THE INVENTION

In accordance with the present invention, there is provided a generating device, comprising a power source, a speed increasing unit driven by the power source and a generating unit driven by the speed increasing unit. The generating unit includes a rotor disposed rotatably, a stator located in and spaced from the rotor and a driven member secured on the rotor to drive and rotate the rotor and provided with a driven gear. The speed increasing unit includes a drive member having a first portion driven and rotated by the power source and a second portion provided with a drive gear and a plurality of transmission gears each intermeshing with the drive gear of the drive member and the driven gear of the driven member.

The primary objective of the present invention is to provide a generating device for an exercising equipment, wherein the generating device has a self-generating function during the user's exercising process so as to provide an electric power to the exercising equipment automatically without needing an external electric power, thereby saving the electric energy.

Another objective of the present invention is to provide a generating device for an exercising equipment, wherein the drive gear of the drive member has a diameter greater than that of each of the transmission gears so that the rotation speed of each of the transmission gears is greater than that of the drive member by the gear ratio of the drive gear of the drive member and each of the transmission gears to increase the rotation speed of the rotor so as to enhance the generating efficiency of the generating unit.

A further objective of the present invention is to provide a generating device for an exercising equipment, wherein the generating efficiency of the generating unit is increased greatly by the gear ratio of the drive gear of the drive member and each of the transmission gears without increasing a burden to the user.

A further objective of the present invention is to provide a generating device for an exercising equipment, wherein the generating efficiency of the generating unit is increased greatly to provide a larger electric power so that the whole size of the generating device can be reduced largely so as to decrease the cost of fabrication.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a generating device in accordance with the preferred embodiment of the present invention.

FIG. 2 is an exploded perspective view of the generating device as shown in FIG. 1.

FIG. 3 is a front cross-sectional view of the generating device as shown in FIG. 1.

FIG. 4 is a perspective view of the generating device for an exercising equipment in accordance with the preferred embodiment of the present invention.

### DETAILED DESCRIPTION OF THE INVENTION

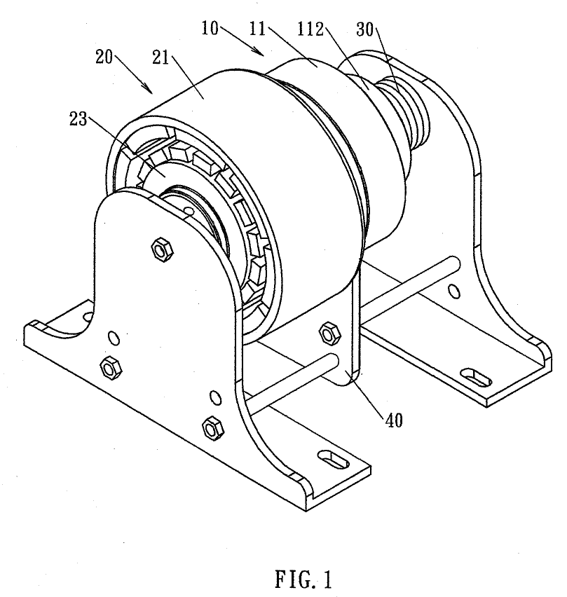

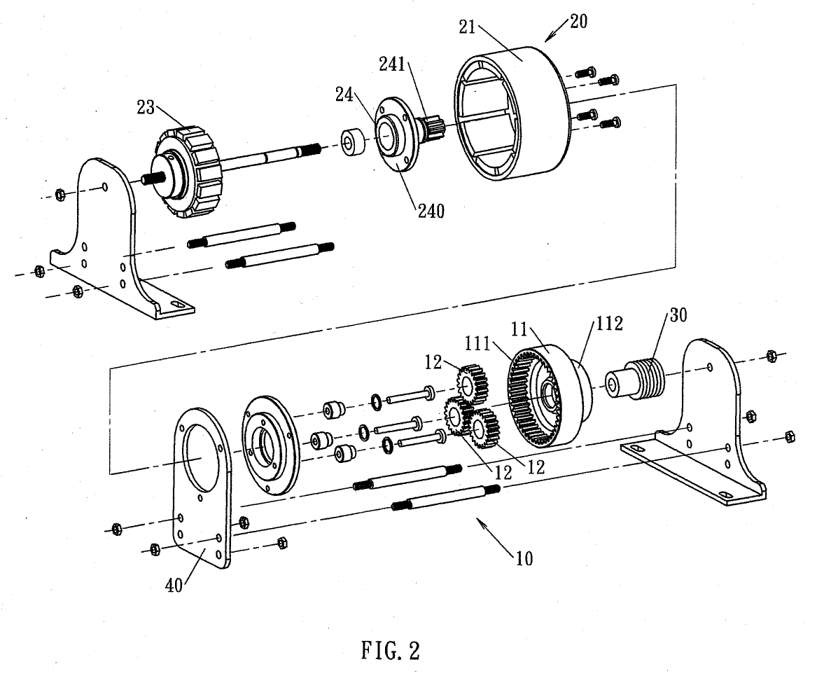

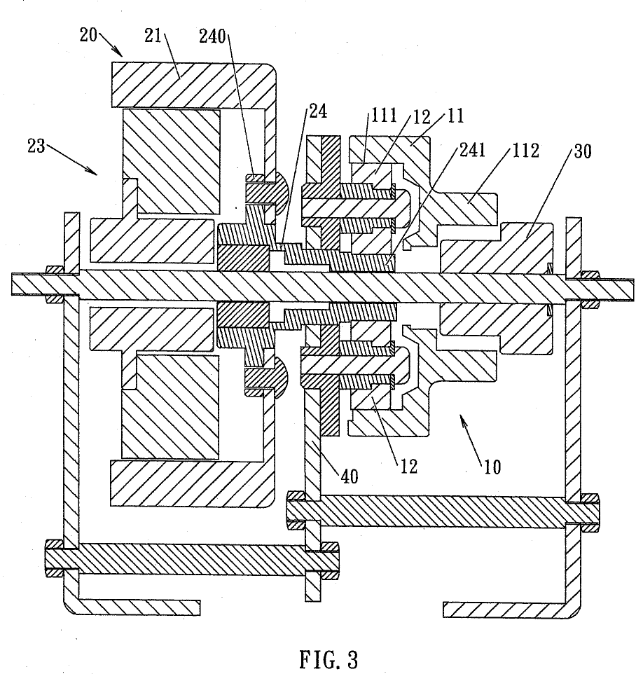

Referring to the drawings and initially to FIGS. 1-3, a generating device for an exercising equipment in accordance with the preferred embodiment of the present invention comprises a power source 30, a speed increasing unit 10 driven by the power source 30 and a generating unit 20 driven by the speed increasing unit 10.

The generating unit 20 includes a rotor 21 disposed rotatably, a stator 23 located in and spaced from the rotor 21 and a driven member 24 secured on the rotor 21 to drive and rotate the rotor 21. The driven member 24 of the generating unit 20 has a first portion provided with a driven gear 241 and a second portion provided with a fixing seat 240 secured on the rotor 21 to drive and rotate the rotor 21. The driven gear 241 of the driven member 24 protrudes outwardly from the rotor 21 of the generating unit 20. The fixing seat 240 of the driven member 24 is located in the rotor 21 and located beside the stator 23.

The speed increasing unit 10 is located beside the generating unit 20 and includes a drive member 11 having a first portion 112 driven and rotated by the power source 30 and a second portion provided with a drive gear 111, and a plurality of transmission gears 12 each intermeshing with the drive gear 111 of the drive member 11 and the driven gear 241 of the driven member 24. Each of the transmission gears 12 of the speed increasing unit 10 is located in and encompassed by the drive gear 111 of the drive member 11. Each of the transmission gears 12 of the speed increasing unit 10 is located between the drive gear 111 of the drive member 11 and the driven gear 241 of the driven member 24. The driven gear 241 of the driven member 24 is located between and meshes with the transmission gears 12 of the speed increasing unit 10. The drive gear 111 of the drive member 11 has an annular shape and has a diameter greater than that of each of the transmission gears 12. The first portion 112 of the drive member 11 has an annular shape and has a diameter smaller than that of the drive gear 111.

The generating device further comprises an upright support bracket 40 for mounting the speed increasing unit 10 and the generating unit 20. The support bracket 40 is located between the speed increasing unit 10 and the generating unit 20. The driven gear 241 of the driven member 24 extends through and protrudes outwardly from the support bracket 40. Each of the transmission gears 12 of the speed increasing unit 10 is rotatably mounted on the support bracket 40.

In operation, again referring to FIGS. 1-3, when the first portion 112 of the drive member 11 is rotated by the power source 30, the drive member 11 is rotated to rotate the drive gear 111 which rotates the transmission gears 12 which rotate the driven gear 241 which rotates the driven member 24 which rotates the rotor 21 so that the rotor 21 is rotated relative to the stator 23 to produce a magnetic reaction between the rotor 21 and the stator 23 so as to generate an electric power by rotation of the rotor 21 relative to the stator 23. In such a manner, the drive gear 111 of the drive member 11 has a diameter greater than that of each of the transmission gears 12 so that the rotation speed of each of the transmission gears 12 is greater than that of the drive member 11 by the gear ratio of the drive gear 111 of the drive member 11 and each of the transmission gears 12 to increase the rotation speed of the rotor 21 so as to enhance the working and generating efficiency of the generating unit 20.

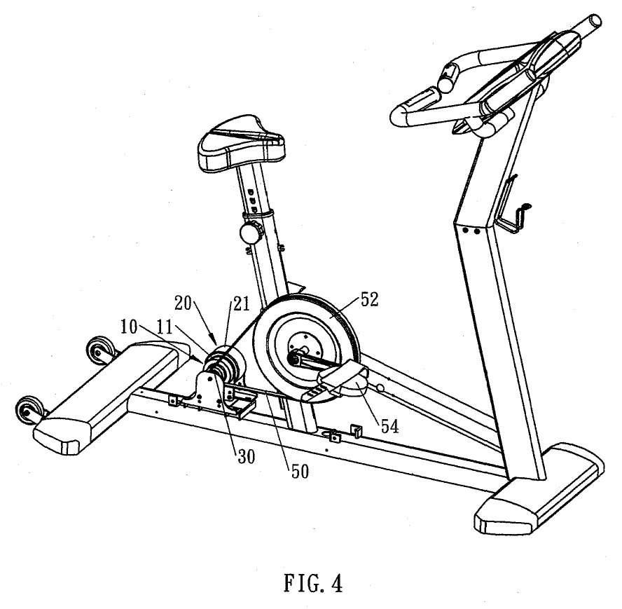

As shown in FIG. 4, when the generating device is mounted on an exercising equipment, such as an exercising bike, a treadmill and the like, the power source 30 is driven by a drive belt 50 which is driven by a rotation disk 52 which is driven by a pedal unit 54 which is driven by a user. Thus, the power source 30 is driven by pedalling of the user to supply a driving force to the speed increasing unit 10 and the generating unit 20 to provide a self-generating function during the user's exercising process so as to provide an electric power to the exercising equipment.

Accordingly, the generating device has a self-generating function during the user's exercising process so as to provide an electric power to the exercising equipment automatically without needing an external electric power, thereby saving the electric energy. In addition, the drive gear 111 of the drive member 11 has a diameter greater than that of each of the transmission gears 12 so that the rotation speed of each of the transmission gears 12 is greater than that of the drive member 11 by the gear ratio of the drive gear 111 of the drive member 11 and each of the transmission gears 12 to increase the rotation speed of the rotor 21 so as to enhance the generating efficiency of the generating unit 20. Further, the generating efficiency of the generating unit 20 is increased greatly by the gear ratio of the drive gear 111 of the drive member 11 and each of the transmission gears 12 without increasing a burden to the user. Further, the generating efficiency of the generating unit 20 is increased greatly to provide a larger electric power so that the whole size of the generating device can be reduced largely so as to decrease the cost of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A generating device, comprising:
a power source;
a speed increasing unit driven by the power source;
a generating unit driven by the speed increasing unit; wherein
the generating unit includes:
a rotor disposed rotatably;
a stator located in and spaced from the rotor;
a driven member secured on the rotor to drive and rotate the rotor and provided with a driven gear;
the speed increasing unit includes:
a drive member having a first portion driven and rotated by the power source and a second portion provided with a drive gear;
a plurality of transmission gears each intermeshing with the drive gear of the drive member and the driven gear of the driven member.

2. The generating device of claim 1, wherein the drive gear of the drive member has an annular shape and has a diameter greater than that of each of the transmission gears.

3. The generating device of claim 2, wherein the first portion of the drive member has an annular shape and has a diameter smaller than that of the drive gear.

4. The generating device of claim 1, further comprising:
an upright support bracket for mounting the speed increasing unit and the generating unit.

5. The generating device of claim 4, wherein the support bracket is located between the speed increasing unit and the generating unit.

6. The generating device of claim 4, wherein the driven gear of the driven member extends through and protrudes outwardly from the support bracket.

7. The generating device of claim 4, wherein each of the transmission gears of the speed increasing unit is rotatably mounted on the support bracket.

8. The generating device of claim 1, wherein the driven member of the generating unit a first portion provided with the driven gear and a second portion provided with a fixing seat secured on the rotor to drive and rotate the rotor.

9. The generating device of claim 8, wherein the fixing seat of the driven member is located in the rotor.

10. The generating device of claim 8, wherein the fixing seat of the driven member is located beside the stator.

11. The generating device of claim 1, wherein the driven gear of the driven member protrudes outwardly from the rotor of the generating unit.

12. The generating device of claim 1, wherein the speed increasing unit is located beside the generating unit.

13. The generating device of claim 1, wherein the each of the transmission gears of the speed increasing unit is located in and encompassed by the drive gear of the drive member.

14. The generating device of claim 1, wherein each of the transmission gears of the speed increasing unit is located between the drive gear of the drive member and the driven gear of the driven member.

15. The generating device of claim 1, wherein the driven gear of the driven member is located between and meshes with the transmission gears of the speed increasing unit.

16. The generating device of claim 2, wherein each of the transmission gears has a rotation speed greater than that of the drive member by a gear ratio of the drive gear of the drive member and each of the transmission gears to increase a rotation speed of the rotor.
